(19) United States
(12) Patent Application Publication
(10) Pub. No.: US 2007/0019023 A1
(43) Pub. Date: Jan. 25, 2007

(54) Stiffness of medium

(76) Inventor: Aaron B. Weast, Camas, WA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/185,571

(22) Filed: Jul. 19, 2005

(51) Int. Cl. B41J 29/38

(52) U.S. Cl. 347/16

(57) ABSTRACT

Embodiments of medium stiffness determination are disclosed.

### BACKGROUND

Some systems and devices that perform functions involving media, such as paper, transparencies, card stock, etc, may at times not perform as well as is desired if operation of the system or device does not account for a stiffness of the media used.

### BRIEF DESCRIPTION OF THE DRAWINGS

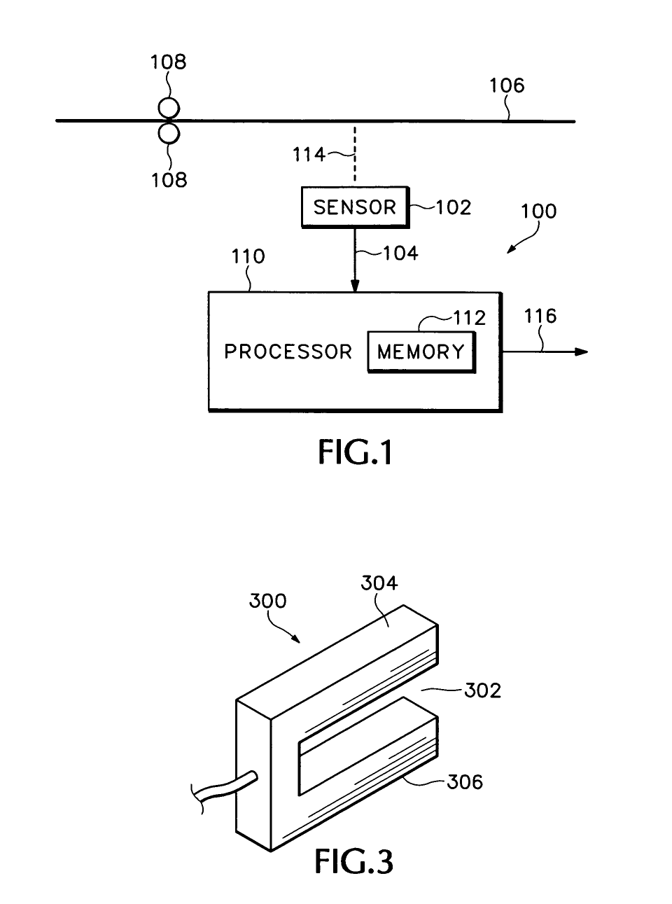

Shown in FIG. 1 is a simplified drawing of an embodiment of an apparatus for providing a signal.

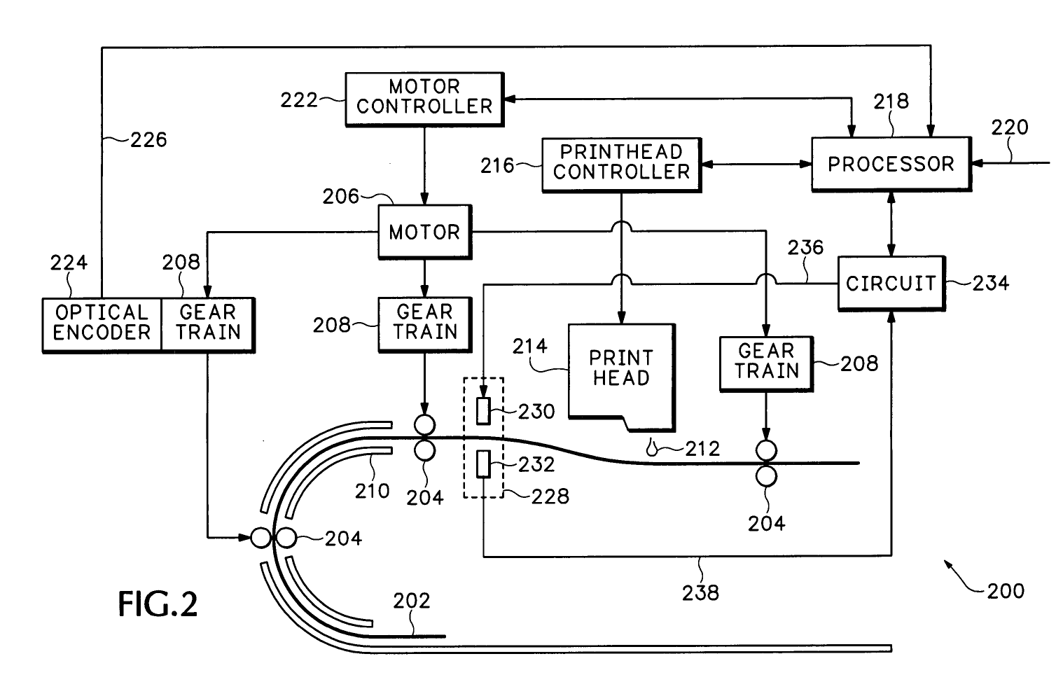

Shown in FIG. 2 is a simplified drawing of an embodiment of an image forming mechanism.

Shown in FIG. 3 is an embodiment of a sensor.

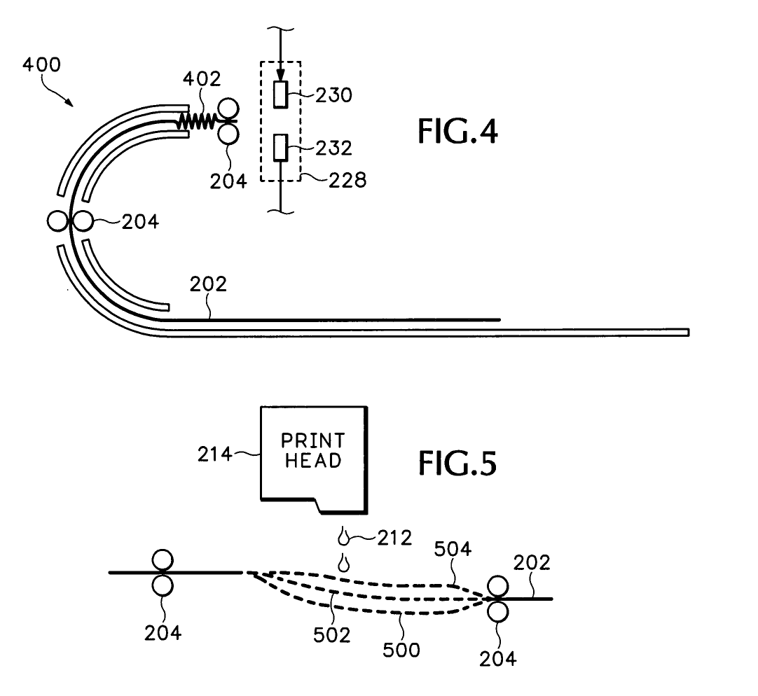

Shown in FIG. 4 is a simplified drawing showing a simplified drawing of a portion of an embodiment of a media path.

Shown in FIG. 5 is a simplified drawing of an embodiment of a fluid ejection mechanism.

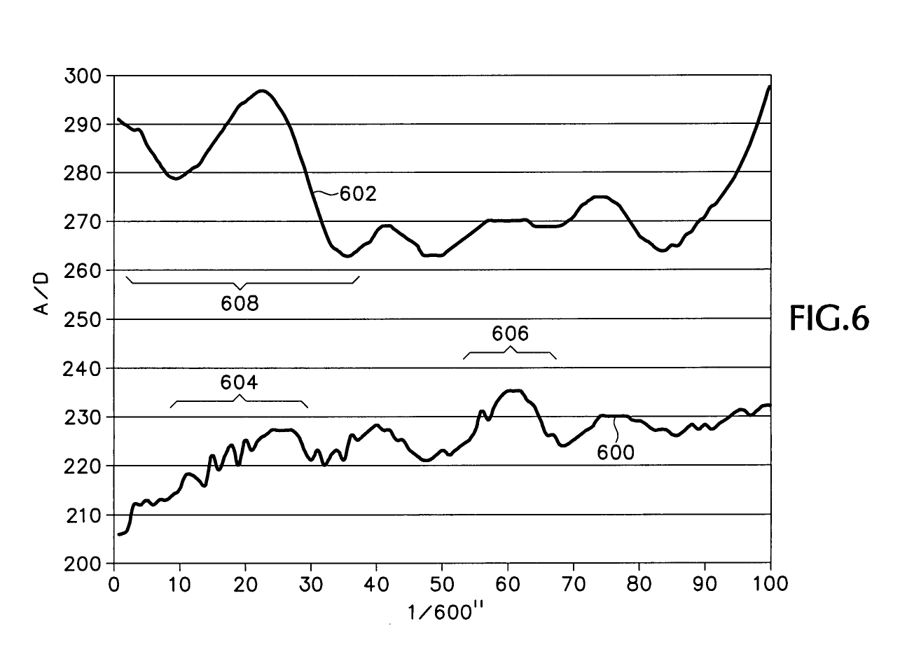

Shown in FIG. 6 is a graph of embodiments of signals.

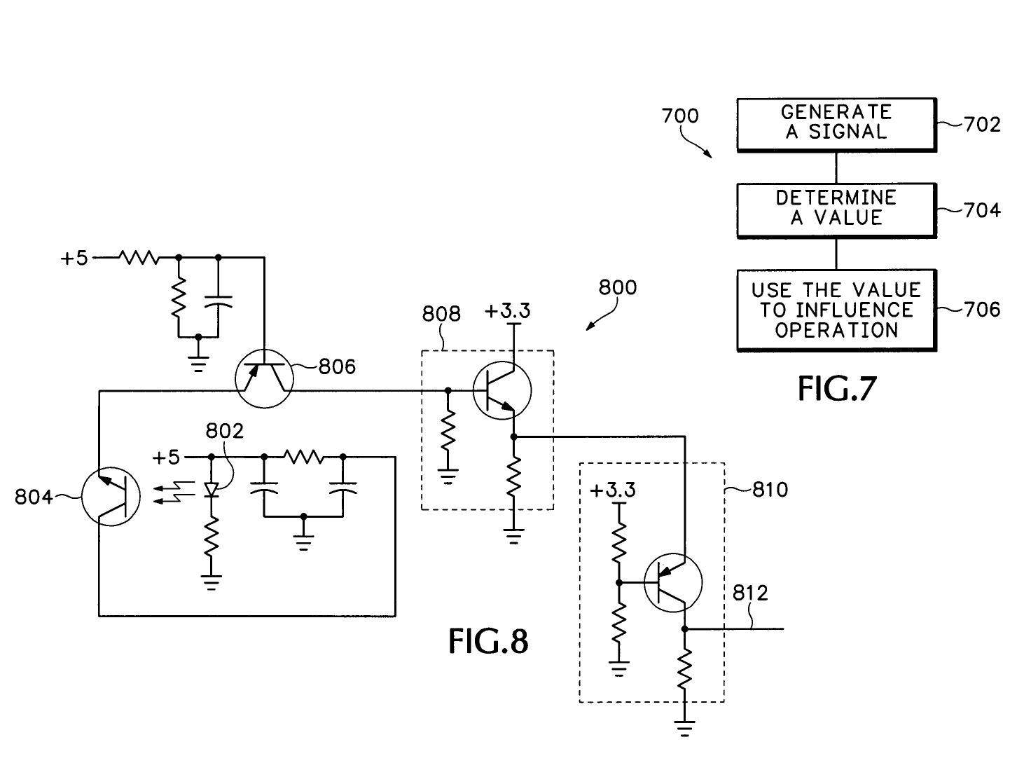

Shown in FIG. 7 is a simplified flow chart of an embodiment of a method.

Shown in FIG. 8 is a simplified schematic of an implementation of a circuit.

### DETAILED DESCRIPTION

Shown in FIG. 1 is a simplified drawing of an embodiment of an apparatus, such as apparatus 100, for providing a signal. An embodiment of a sensor, such as sensor 102, includes a configuration to output an embodiment of a signal, such as signal 104 that is indicative of a distance between sensor 102 and a medium, such as medium 106. For example, an amplitude of signal 104 may change responsive to the distance changing. Sensor 102 may include any sensor suitable for providing signal 104 that changes in response to a change in the distance between sensor 102 and medium 106. In various embodiments, sensor 102 may be implemented using a transmissive optical sensor, a reflective optical sensor, a capacitive sensor, an ultrasonic sensor, or the like. Medium 106 may include any suitable type of medium, such as paper, transparencies, card stock, and the like, that can be moved through a media path. In FIG. 1, drive rollers 108 are a simplified representation of structure that may be used to move medium 106 past sensor 102.

An embodiment of a processing device, such as processor 110 is configured to receive signal 104 provided by sensor 102. Processor 110 may be implemented, for example, using a general purpose processor executing firmware and/or software to accomplish its assigned task, or using an application specific integrated circuit. As medium 106 moves past sensor 102, sensor 102 generates signal 104 so that there is variation in signal 104 as distance 114 between medium 106 and sensor 102 changes. Processor 110 includes a configuration to determine an output 116, using signal 104 that is related to a stiffness of medium 106. In one embodiment, processor 110 determines output 116 using the variation in signal 104. In one embodiment, the output 116 corresponds to a value, such as a digital value, providing an indication of the stiffness of medium 106. This value may not be a value having recognized units for quantifying the stiffness of units of media, but could be a value that provides a relative indication of the stiffness of medium 106. Alternatively, output 116 may correspond to a value that could be used by another device and/or system to make a change to an operating parameter of the device and/or system that is based upon the stiffness of medium 106.

Processor 110 may include an embodiment of a computer readable medium, such as memory 112, that may used for storing processor executable instructions for controlling the operation of processor 110. In various embodiments of apparatus 100, the software or firmware used for the operation of processor 110 may be stored on an embodiment of a computer-readable media included with or separate from processor 110. More generally, a computer readable medium can be any media that can contain, store, or maintain programs and data for use by or in connection with the execution of instructions by a processing device. Computer readable media can comprise any one of many physical media such as, for example, electronic, magnetic, optical, electromagnetic, infrared, semiconductor media, or any other suitable media. More specific examples of suitable computer-readable media include, but are not limited to, a portable magnetic computer diskette such as floppy diskettes or hard drives, a random access memory (RAM), a read-only memory (ROM), an erasable programmable read-only memory, or a portable compact disc. Computer readable media may also refer to signals that are used to propagate the computer executable instructions over a network or a network system such as the Internet.

In one embodiment of processor 110, processor 110 may include an analog to digital converter that generates digital values corresponding to values of signal 104, with individual of the values measured over small time intervals. It should be recognized that embodiments of apparatus 100 may be configured to measure the individual of the values of signal 104 after incremental advances of medium 106. In some embodiments of apparatus 100, the incremental advances of medium 106 correspond to a distance of 1/600^{th} of an inch. For these embodiments of apparatus 100, where medium 106 is moved at a substantially constant speed, a group of measurements of values of signal 104 will, collectively, be performed over a relatively short time period. However, where medium 106 is stopped and then started again in one or more instances during the time period in which the group of measurements is made, the group of measurements of values of signal 104 will, collectively, be performed over a relatively longer time period. Alternatively, sensor 102 may be configured so that signal 104 includes digital values, or a separate analog to digital converter external to processor 110 and sensor 102 to provided digital values to processor 110 may be included in an embodiment of apparatus 100.

Additionally, in embodiments of apparatus 100, signal conditioning, such as filtering, may be performed on signal 104 to attenuate contributions to the variability of signal 104 caused by things other than changes in distance 114 closely related to stiffness of medium 106. For some environments in which apparatus 100 is operated these other things may contribute to a significant and undesired amount of variability in signal 104. One of the things that may provide such a contribution includes electrical noise induced in and/or coupled to the circuit that includes sensor 102. The source of the electrical noise may be a system or device that includes apparatus 100 or the source of the electrical noise may be external to the system or device that includes apparatus 100. In some applications, a significant portion of the energy associated with the electrical noise exists at frequency ranges different than the frequency ranges associated with the variability of signal 104 resulting from changes in distance 114. In such circumstances, low pass, band pass, or high pass filtering may be used to attenuate the contribution to the variability of signal 104 arising from electrical noise or sources of variability in signal 104 that are less closely associated with stiffness of medium 106. Which one or more type of filtering will be selected may depend upon the frequency ranges in which the electrical noise exists. It should be recognized that the filtering could be implemented using analog and/or digital filtering techniques.

It has been determined that the stiffness of medium 106 influences the degree to which the distance 114 changes as medium 106 moves past sensor 102. For medium 106 having a relatively greater stiffness, which may be associated with relatively thicker of medium 106, there is, in general, a relatively smaller degree of change in the distance 114 as medium 106 moves past sensor 102 than is the case for medium 106 having relatively less stiffness. The relatively smaller degree of change may manifest itself as relatively smaller magnitude changes in distance 114 and/or relatively less variability in the distance 114. For medium 106 having relatively less stiffness, which may be associated with relatively thinner of medium 106, there is in general, a relatively larger degree of change in the distance 114 as medium 106 moves past sensor 102 than is the case for medium 106 having relatively greater stiffness. The relatively larger degree of change may manifest itself as relatively larger magnitude changes in distance 114 and/or relatively greater variability in the distance 114. Changes occurring in distance 114, as medium 106 moves past sensor 102, result in changes in the signal 104 provided by sensor 102.

In an embodiment of processor 110, output 116 may be determined from an analysis of signal 104. This analysis may include a statistical analysis of the group of measurements of the values of signal 104 made. As mentioned in the previous paragraph, changes in distance 114 result in changes in signal 104 so that quantifying the variability of signal 104 provides an indication of the stiffness of medium 106. Some parameters that may be used to characterize signal 104 include statistical measures providing indications of the variability of data. Some parameters that may be used include the standard deviation, variance, R-squared, and the like.

In one embodiment processor 110 measures individual values of signal 104 over various short time intervals and determines output 116 based upon these values. As previously mentioned the output value 116 so determined provides an indication of the variability of signal 104 that is related to a stiffness of medium 106. In some embodiments, the statistical measure, determined from values of signal 104 may be used for output 116. In other embodiments, the statistical measure may be used to determine output 116. For example, output 116 may be determined computationally from the determined statistical measure or output 116 may determined using a look up table accessed based upon the determined statistical measure. Where output 116 is determined based upon the statistical measure, output 116 may correspond to a value that is used by another system or device associated with apparatus 100 to set an operating parameter of the system or device.

Shown in FIG. 2 is a simplified drawing of an embodiment of an image forming mechanism, image forming mechanism 200. In image forming mechanism 200, a medium, such as sheet of paper 202 may be moved through a media path (illustrated generally as u-shaped path taken by paper 202) during an image forming operation. Rollers 204 are used to assist in the movement of paper 202 through image forming mechanism 200. Paper 202 passing between rollers 204 is pulled and/or pushed along the media path. Actuation of rollers 204 results from the operation of motor 206 through gear trains 208, as illustrated schematically in FIG. 2. Media guides 210 assist in guiding paper 202 along the media path. An image may be formed on paper 202 by ejecting a colorant, such as ink 212, onto paper 202 as paper 202 moves past an embodiment of a fluid ejection mechanism, such as printhead 214. By ejection of ink 212 onto paper 202 at the appropriate times as paper 202 moves past printhead 214, desired images, such as text, graphics, or pictures, may be formed on paper 202.

Although embodiments of determining stiffness of a medium disclosed with respect to FIG. 2 are discussed in the context of an embodiment of an image forming mechanism corresponding to an inkjet image forming mechanism, it should be recognized that the disclosed structures and methods may be usefully applied in other types of image forming mechanisms, such as electrophotographic image forming mechanisms or image forming mechanisms used in offset printing, for which information related to the stiffness of a medium could be beneficially used for the operation of the image forming mechanism. Furthermore, it should be recognized that the disclosed structures and methods may be usefully applied in media handling mechanisms for which information related to the stiffness of a medium could be beneficially used for the operation of media handling mechanism.

In one embodiment of printhead 214, power applied to resistors included in printhead 214 results in the ejection of ink drops from printhead 214. An embodiment of a controller, such as printhead controller 216, generates signals to provide to printhead 214 that result in the application of electrical power to the appropriate ones of the resistors to result in ejection of ink from selected nozzles in printhead 214 to form the desired image on paper 202. An embodiment of a processing device, such as processor 218, includes a configuration to receive data 220 related to the image to be formed on paper 202. Processor 218 may be configured to perform the appropriate operations on data 220 to render data 220 into a form usable by printhead controller 216 to generate the appropriate signals that results in the ejection of drops of ink 212 from printhead 214 at the appropriate times to form the desired image on paper 202. In some embodiments an application specific integrated circuit may be used for the processing device.

An embodiment of a controller, such as motor controller 222, generates the appropriate signals to control operation of motor 206. Among other things, motor controller 222 controls the operation of motor 206 to achieve the desired movement, during the desired time periods, of paper 202 through the media path of image forming mechanism 200. In some embodiments, motor controller 222 generates signals to provide to motor 206 so that it operates in a manner suitable to move paper a desired distance and/or and a desired rate along the media path. An embodiment of an encoder, such as optical encoder 224, provides a signal 226, such as a series of pulses generated in response to rotational movement of gear train 208, to processor 218 indicating the amount of rotation of the associated gear train 208 and the rotational position of gear train 208. The signal 226 provided to processor 218 is used as position and speed feedback so that processor 218, motor controller 222, and motor 206 may be operated to achieve closed loop control of the position of paper 202 and speed profile experienced by paper 202 as it traverses the media path during an image forming operation.

An embodiment of a sensor, such as sensor 228, may be used to generate a signal indicating the presence or absence of paper 202, at the position of sensor 228 along the media path, during an image forming operation. The particular embodiment of sensor 228 used in image forming mechanism 200 includes an emitter 230 to emit light and a detector 232 to detect the light provided by emitter 230. An embodiment of a circuit, such as circuit 234 provides a signal 236 used to supply current to emitter 230 to result in light emission. Circuit 234 also receives a signal 238 from detector 232 that provides an indication of the amount of light received by detector 232. Circuit 234 includes a configuration to provide the appropriate conditioning to signal 238 so that it is in a form suitable for use by processor 218. The conditioning applied to signal 238 may include, for example, low pass filtering, band pass filtering, high pass filtering, clipping, and/or level shifting. It should be recognized that in other embodiments of processor 218 the hardware and associated functions of circuit 234 may be partially or fully implemented in processor 218 and that in other embodiments of sensor 228 the functions of circuit 234 may be partially or fully implemented within sensor 228.

Shown in FIG. 3 is an embodiment of a sensor that may be used for sensor 228. The sensor 300 includes two prongs extending from a base so that a gap, such as gap 302 exists between the two prongs. In sensor 300, prong 304 may include emitter 230 and prong 306 may include detector 232. The volume bounded by light emitted by emitter 230 is generally in the shape of a cone. The detector 232 is positioned and configured to receive at least a portion of the light within this cone. In one embodiment, detector 232 is positioned and configured to receive a central portion of the light included in this cone.

When paper 202 moves in gap 302, while emitter 230 is emitting light, the light that passes through paper 202 may have its direction of propagation changed by the materials, such as paper fibers, forming paper 202. This change in the direction of propagation may change the shape of the cone of light that impinges upon detector 232, as compared to the case in which no paper 202 is located in gap 302. For example, light propagating through paper 202 may result in broadening of the cone of light where it impinges upon detector 232. A change in the shape of the cone of light where it impinges upon detector 232 would reduce the light flux incident on detector 232, as compared to the case in which no paper 202 is located in gap 302, thereby reducing a magnitude of the signal provided by detector 232, as compared to the case in which no paper 202 is located in gap 302.

The light flux incident upon detector 232 may also be affected by a position, with respect to prong 304 and prong 306, of paper 202 within gap 302. For example, with paper 202 located closer to emitter 230 the shape of the cone incident upon detector 232 may be broader than it would be with paper 202 located farther from emitter 230, thereby resulting in less light flux reaching detector 230. Accordingly, the magnitude of the signal provided by detector 232 would be lower with paper 202 located closer to emitter 230 than it would be with paper 202 located farther from emitter 230. For paper 202 having a relatively low degree of stiffness, paper 202 will flex more as it moves through gap 302, thereby resulting in a magnitude of a distance of paper 202 from the emitter to change more than would result with a relatively high degree of stiffness. In this manner the magnitude of the signal provided by detector 232 could vary as a position of paper 202 within gap 302 changes.

It should be recognized that other emitter and detector configurations and/or geometries may result in different relationships between the magnitudes of the signal provided by the detector as a position of paper 202 with respect to the detector changes. For example, in some embodiments of sensor 300, the emitter, the detector, or both the emitter and detector may be recessed from the surface of prong 302 or prong 306 facing gap 302, thereby affecting the light flux reaching the detector. Furthermore, for sensors of other types, the underlying factors that result in a magnitude of a signal provided by the sensor changing as a distance between the senor and a medium change will likely be different.

Shown in FIG. 4 is a simplified drawing showing a simplified drawing of a portion of an embodiment of a media path, media path 400. FIG. 4 illustrates a situation in which paper 202 has experienced a media jam, as illustrated by the folded region 402 of paper 202. As previously mentioned, the signal 226 provided by optical encoder 224 to processor 218 is used as position and speed feedback so that processor 218, motor controller 222, and motor 206 may be operated to achieve closed loop control of the position of paper 202 and speed profile experienced by paper 202 as it traverses the media path during an image forming operation.

Processor 218 monitors the signal 238 provided by detector 232 (and as conditioned by circuit 234) to determine, among other things the progress of paper 202 through media path 400. For units of paper 202 having relatively high stiffness, the torque that would be applied by motor 206 through gear train 208 to rollers 204 to achieve a desired speed of movement of paper 202 through media path 400 would be greater than for units of paper 202 having relatively low stiffness. Without speed feedback, such that motor 206 applies substantially constant torque to rollers 204, it would be expected that units of paper 202 having relatively high stiffness would move through media path 400 more slowly than units of paper 202 having relatively low stiffness. With speed feedback, motor controller 222 may operate to cause motor 206 to increase, decrease, or maintain the torque applied to rollers 204 depending upon whether the speed of paper 202 through media path 400 is determined to be too low, too high, or within the desired range of speeds.

One way in which motor controller 222 may control the torque applied by motor 206 to rollers 204 is by adjusting pulse width of the signal applied to motor 206, for example in an implementation in which motor 206 includes a DC motor. However, when a media jam occurs, increasing the torque applied to rollers 204 to maintain movement of paper 202 through media path 400 at a desired speed results in a greater degree folding of paper 202 than would have occurred without increasing the torque applied to rollers 204. With folded region 402 occurring, eventually a media jam condition would be detected because sensor 228 would not provide a signal indicating that paper 202 was passing between emitter 230 and detector 232. Or, the speed feedback would result processor 218 determining that the torque that would be applied to by motor 206, in an attempt to have paper 202 reach a desired speed, would exceed an allowable torque threshold.

A consideration involved in setting the allowable torque threshold is determining the appropriate balance between setting the allowable torque threshold low enough to reduce the likelihood of severe media jams for relatively low stiffness mediums while setting the allowable torque threshold high enough to move relatively high stiffness mediums at the desired speed. One way to accomplish these objectives is by setting the allowable torque threshold according to a determination of the stiffness of the medium made by processor 218 using the signal 238 conditioned by circuit 234. The determination of the stiffness of the medium could be made on one unit of a medium and used for at least some of the units of media to be used in an image forming operation. Or, the determination of the stiffness of the medium could be done for each unit of the medium passing through media path 400. For this implementation sensor 228 (or another of sensor 228) could be located near the entrance of paper 202 into media path 400 so that the allowable torque threshold is set near or before the time paper 202 enters media path 400.

Shown in FIG. 5 is a simplified drawing of an embodiment of a fluid ejection mechanism, such as printhead 214. FIG. 5 illustrates, in simplified (and in an exaggerated fashion for ease of illustration) how paper 202 having different stiffness may affect the placement of ink drops 212 onto paper 202. For paper 202 having the relatively lowest stiffness (following dashed line 500), the location at which ink drops 212 would be placed onto paper 202 would be different from the location at which ink drops 212 would be placed onto paper 202 for the relatively greatest stiffness (following dashed line 504), or paper 202 having an intermediate stiffness (following dashed line 502) because of the different paths paper 202 having different stiffness would follow.

Using the signal 238 conditioned by circuit 234, processor 218 may be configured to determine an indication of the stiffness of a medium moving through media path 400 and adjust the data provided to printhead controller 216 to at least partially compensate for stiffness differences that may exist between different mediums. One way in which this compensation may be accomplished is through adjustment of the timing information associated with the data provided to printhead controller 216. By delaying in time or advancing in time the ejection of ink drops 212 from printhead 214, based upon the value related to stiffness of the medium, the effect of medium stiffness in causing placement of ink drops 212 in undesired locations may be offset. Whether the ejection of ink drops 212 is delayed in time or advanced in time depends, in part, on the relationship between the value related to the stiffness of the medium and what is considered as the nominal stiffness accounted for in the timing information included with the data supplied by processor 218 for use by printhead controller 216. The adjustment in the timing of the ejection of ink drops 212 may be done based upon a value related to stiffness determined for individual of the medium or based upon a value related to stiffness determined for one unit of a medium and used for at least some of the units of media to be used in an image forming operation

Shown in FIG. 6 is a graph of embodiments of signals. The vertical axis corresponds to output values of an analog to digital converter conversion value of signals from an embodiment of a sensor. The signals correspond to the output of the sensor during times that paper of different stiffness move past the sensor. The horizontal axis corresponds to distance measured as increments of 1/600^{th} of an inch. With the paper moving at a substantially constant speed, the horizontal axis will be proportional to time. Signal 600 corresponds to measurements associated with paper having a relatively low stiffness. Signal 602 corresponds to measurements associated with paper having a relatively high stiffness.

The measurements for signal 600 and signal 602 were derived using a sensor that include an emitter and a detector positioned on the opposite side of the medium to measure infra-red light transmitted through the medium. As can be seen from FIG. 6, signal 600 and signal 602 have different average values. It turns out that for some types of paper a smaller thickness of the paper, generally associated with less stiffness, may be more opaque (likely resulting from characteristic of the fibers included in the paper) than paper having a greater thickness, generally associated with greater stiffness. This explains the relationship shown in FIG. 6 in which the less stiff and smaller thickness paper attenuates (and therefore has a lower average analog to digital converter conversion value) more light than the paper having a greater thickness and greater stiffness.

Close observation of the characteristics of signal 600 and signal 602 reveal that signal 600 has a greater variability at relatively higher frequencies, such as for region 604 of signal 600, than signal 602. This greater variability at relatively higher frequencies for signal 600 results from the lower stiffness of the paper from which signal 600 was derived than the stiffness of the paper from which signal 602 was derived. The lower stiffness results in changes in the distance between the paper and the sensor that occur at relatively higher frequencies. The relatively lower frequency variations displayed in both signal 600 and signal 602, such as for region 606 of signal 600 and region 608 of signal 602, can result from changes in the distance between the paper and the sensor that come about from the interaction of the paper with hardware in the media path, such as rollers 204.

The component of the variability of signal 600 and signal 602 used to determine differences between the stiffness of the paper from which signal 600 and signal 602 was derived can be measured by determining statistical parameters such as standard deviation, variance, or R-squared without filtering of the corresponding signal 602 and signal 600. However, these differences may be more pronounced if one or more of these statistical parameters is determined using filtered versions (either filtered in the analog domain and/or the digital domain) of signal 600 and signal 602. For example, by applying high pass (or perhaps band pass filtering to attenuate higher frequency electrical noise) filtering to signal 600 and signal 602 and then determining one or more of the statistical parameters, the contribution to the measure of variability from sources other than the relatively high frequency changes in distance between the sensor and the paper will be reduced. This would result in less difficulty in determining differences in stiffness between mediums relatively close in stiffness.

Shown in FIG. 7 is a simplified flow chart of an embodiment of a method, such as method 700. In step 702 a signal is generated. In one embodiment the signal provides an indication of a distance between a sensor and a medium, such as paper. In one embodiment, the signal may provide the indication of the distance through changes in values of the signal that occur in response to changes in the distance between the sensor and the medium. In another embodiment, the signal may be generated while moving the medium past the sensor.

In step 704, a value is determined. In one embodiment, the value may be determined using the signal and the value may be related to a stiffness of the medium. In another embodiment, the value may be determined by determining a parameter related to a variability of the signal during a time period of movement of the medium is moved past the sensor. The parameters may include, for example, one of a standard deviation, variance, and R-squared.

In step 706, the value may be used to influence operation of some device or system, such as an image forming system. For example, the value may be used to determine a torque threshold used by motor controller 222 to control the operation of motor 206. Or, adjustments to the timing of the ejection of ink from printhead 214 may be made using the value.

Shown in FIG. 8 is a simplified schematic of an implementation of a circuit, such as circuit 800, which may be used for an embodiment of circuit 234 where the embodiment of image forming mechanism 200 makes use of an application specific integrated circuit for the processing device. For the embodiment of the circuit 234, LED 802 is an implementation of emitter 230 and phototransistor 804 is an implementation of detector 232. Transistor 806 buffers the current received from phototransistor 804. The components included in circuit 808 operate to amplify the output of transistor 806. The components included in circuit 810 operate as a voltage clamp to maintain output 812 within a range of voltage compatible with the allowed input voltage range of the application specific integrated circuit to which output 812 would be coupled.

While the disclosed embodiments have been particularly shown and described, those skilled in the art will understand that many variations may be made to these without departing from the spirit and scope defined in the following claims. The detailed description should be understood to include all novel and non-obvious combinations of the elements that have been described, and claims may be presented in this or a later application to any novel and non-obvious combination of these elements. Combinations of the above exemplary embodiments, and other embodiments not specifically described herein will be apparent to those of skill in the art upon reviewing the above detailed description. The foregoing embodiments are illustrative, and any single feature or element may not be included in the possible combinations that may be claimed in this or a later application. Therefore, the scope of the claimed subject matter should be determined with reference to the following claims, along with the full range of equivalents to which such claims are entitled.

What is claimed is:

1. An apparatus, comprising:
a sensor to output a signal indicative of a distance between the sensor and a medium; and
a processing device configured to determine an output, related to a stiffness of the medium, using the signal.

2. The apparatus as recited in claim 1, wherein:
the sensor includes a first member having an emitter and a second member having a detector, with the first member and the second member forming a gap for passage of the medium therethrough, with the distance corresponding to a distance between the medium and the emitter.

3. The apparatus as recited in claim 1, further comprising:
an image forming mechanism to place colorant on the medium.

4. The apparatus as recited in claim 3, wherein:
the colorant includes ink and the image forming mechanism includes a fluid ejection mechanism for ejection of the ink onto the medium.

5. The apparatus as recited in claim 4, further comprising:
with the output including a value, a controller coupled to the fluid ejection mechanism to control the ejection of the ink, with the processing device including a configuration to determine the value for use by the controller to adjust the ejection of the ink to at least partially compensate for an effect of the stiffness on placement of the ink of the medium.

6. The apparatus as recited in claim 1, further comprising:
with the output including a value, a motor configured to cause movement of the medium; and
a controller to control operation of the motor, with the processing device including a configuration to determine the value for use by the controller to limit torque supplied by the motor based upon the stiffness of the medium.

7. The apparatus as recited in claim 1, wherein:
the sensor includes one of a transmissive optical sensor, a reflective optical sensor, a capacitive sensor, and an ultrasonic sensor.

8. The apparatus as recited in claim 1, wherein:
the processing device includes a configuration to determine the value by accessing a memory for storing a plurality of numbers using the signal.

9. The apparatus as recited in claim 1, wherein:
the processing device includes a configuration to determine the value from computations using the signal.

10. The apparatus as recited in claim 1, wherein:
the processing device includes a configuration to determine the output using changes in the signal resulting from changes in the distance.

11. The apparatus as recited in claim 1, wherein:
the processing device includes a configuration to perform one of high pass filtering and bandpass filtering on values of the signal.

12. The apparatus as recited in claim 1, further comprising:
circuitry configured to perform one of high pass filtering and band pass filtering on the signal.

13. A method, comprising:
generating a signal indicating a distance between a sensor and a medium; and
determining a value, using the signal, related to a stiffness of the medium.

14. The method as recited in claim 13, further comprising:
moving the medium past the sensor.

15. The method as recited in claim 13, wherein:
the determining the value includes determining a parameter related to variability of the signal during a time period of movement of the medium past the sensor.

16. The method as recited in claim 15, wherein:
the parameter includes one of a standard deviation, variance, and R-squared.

17. The method as recited in claim 13, further comprising:
determining an adjustment to ejection of ink using the value.

18. The method as recited in claim 17, wherein:
the determining the adjustment includes determining a change in a time of the ejection of the ink using the value.

19. The method as recited in claim 18, further comprising:
changing the time of the ejection of the ink according to the adjustment.

20. The method as recited in claim 13 further comprising:
determining a torque threshold for a motor using the value.

21. The method as recited in claim 20, further comprising:
stopping operation of the motor if current to be applied to the motor would result in exceeding of the torque threshold.

22. The method as recited in claim 13, further comprising:
filtering the signal using one of high pass filtering and band pass filtering.

23. The method as recited in claim 22, wherein:
the determining the value using the signal includes using a filtered signal.

24. A computer readable medium, comprising:
a device to store processor executable instructions to control a processing device to determine a value, based upon a signal indicating a distance between a sensor and a medium, related to a stiffness of the medium.

25. The computer readable medium as recited in claim 24, wherein
the processor executable instructions include instructions to determine a parameter related to variability of the signal during a time period of movement of the medium past the sensor.

26. The computer readable medium as recited in claim 25, wherein:
the parameter includes one of a standard deviation, variance, and R-squared.

27. The computer readable medium as recited in claim 24, wherein:
the processor executable instructions include instructions to perform filtering on the signal, with the processor executable instructions to determine the value using a filtered signal.

28. The computer readable medium as recited in claim 24, wherein:
the processor executable instructions to determine the value include instructions to access the value from a memory, based upon computations using the signal.

29. An apparatus, comprising:
a means for providing a signal based upon a gap between a sensor and a medium; and
a means for determining a value, indicative of a stiffness of the medium, based upon a variation of the signal.

30. The apparatus as recited in claim 29, further comprising:
a means for forming an image on the medium.
